(19) United States
(12) Patent Application Publication
(10) Pub. No.: US 2007/0140789 A1
(43) Pub. Date: Jun. 21, 2007

(54) Bicycle components having coupling portions, and coupling provided thereby

(75) Inventor: Mario Meggiolan, Creazzo (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 11/706,545

(22) Filed: Feb. 13, 2007

Related U.S. Application Data
(63) Continuation of application No. 10/410,533, filed on Apr. 9, 2003.

(30) Foreign Application Priority Data
Apr. 9, 2002 (EP) 02425217.3

(51) Int. Cl. B25G 3/00

(52) U.S. Cl. 403/383; 280/200

(57) ABSTRACT

A component coupling arrangement with at least one male and one female coupling zone that finds particular use for connecting bicycle components. The two coupling zones, male and female, have respective reciprocal trilateral engaging surfaces.

### CROSS REFERENCE TO RELATED APPLICATION

This application is a continuation of U.S. patent application Ser. No. 10/410,533, filed Apr. 9, 2003, which is incorporated by reference as if fully set forth.

### FIELD OF INVENTION

The present invention relates generally to coupling components with male and female coupling zones and more particularly to coupling bicycle components.

### BACKGROUND

In bicycles generally and specifically in racing bicycles, there is an increasing need to produce components and couplings which are simple in their construction, sturdy and light. Simplicity of the component is intended both in the sense of allowing coupling and decoupling of the connected parts with extremely easy and fast operations, and to manufacture of the component. Sturdiness is also fundamental to stability of the connection and reliability of the component under high stresses, such as tractive, bending and torsional stress. Finally, the structure of the coupling component should be as light as possible, in order to contribute towards maximum efficiency of the bicycle.

In the prior art various types of connection devices have been proposed. For example, the assignee of the present application has for some time been manufacturing and marketing bicycle pedal cranks which are coupled to the bottom bracket spindle by means of a male element composed of a portion with square section formed on one end of the spindle and a cavity with corresponding profile formed in the pedal crank. Reciprocal engaging of the male element in the cavity guarantees both the assembly position of the pedal crank in relation to the spindle axis, and transmission of bending, shearing and torsional stress between spindle and pedal crank. Axial locking of the pedal crank on the spindle is made with a lock screw that engages a threaded axial hole formed in the spindle from its end surface and which has a head that rests against a respective seat formed in the pedal crank.

Still in the field of spindle-pedal crank coupling devices, other coupling devices are also known, with a male element and a cavity with grooved surfaces, as illustrated for example in EP-A-0 756 991 and before this in FR-A-1 273 107. However, these solutions are not entirely satisfactory, especially as regards simplicity of the manufacturing operations and relative production costs.

The object of the present invention is to produce a coupling component of the type indicated at the beginning of the present description, which seeks to satisfy in the best possible manner all the requirements mentioned above.

### SUMMARY

With a view to attaining this object, the invention relates to components with male and female coupling zones having respective reciprocal engaging surfaces that are characterized by a trilateral profile.

Thanks to this characteristic, the component according to the invention, provides the necessary precision and sturdiness of connection, and can be made with relatively simple and low cost manufacturing operations. Simultaneously, the trilateral profile conformation is ideal also from the point of view of simplicity and lightness of the component. The trilateral profile may have one or more rectilinear, or partly curved, sides, according to any possible combination. The curved sides may be arched towards the centre of the profile or towards the outside of the profile. The profile may be equilateral or irregular with all sides differing from one another.

According to a preferred embodiment, the trilateral profile has one or more rounded vertices and preferably all three rounded vertices in order to define a trilobate profile. The three sides of the trilobate profile may also be concaved towards the inside of the triangle, in order to define a figure with three radial petals, angularly spaced apart.

According to another preferred aspect of the invention, the aforesaid engaging surfaces of the male coupling zone and of the female coupling zone have first engaging portions with the aforesaid trilateral profile and second engaging portions, in a position axially moved in relation to the first portions, with a circular profile. In this way, reciprocal engaging of the portions with triangular profile provides the sturdiness and stability of the coupling, especially with reference to the transmission of torsional stresses in relation to the common axis of the male and female coupling zones, while the portions with the circular section provides precision of the relative positioning of the two elements, especially with reference to possible misalignments of the axes of the coupling zones.

Again according to the invention, the aforesaid engaging surfaces may be dimensioned so that they couple with an interference fit. In the aforesaid case where the first coupling portions have a trilateral profile and the second coupling portions have a circular profile, both pairs of portions of coupling surfaces are assembled with an interference fit.

It is also possible both for the aforesaid reciprocally engaging surfaces of the coupling zones to have an axially uniform section, and for those surfaces to be axially tapered.

In the second case, each of the two coupling zones has for example a conic conformation with rectilinear generating lines, with a total cone angle between 1° and 45°, and preferably between 5° and 10°. Alternatively, the aforesaid tapered conformation may be for example slightly convex, with generating lines arched towards the outside or be saddle-shaped, with generating lines arched towards the inside.

According to another possible aspect of the invention, the trilobate profile of the male and female coupling zones is configured in order to make the coupling only in line with the three lobes, or the three rounded vertices of the profile. This may be obtained for example by concaving the sides of the trilateral profile of the male coupling zone, by concaving the sides of the trilateral profile of the female coupling zone, or by concaving both of the aforesaid coupling zones.

According to an alternative aspect, the trilobate profile of the male and female coupling zones is configured to make the coupling only in line with the three sides, and not in line with the three lobes or vertices of the profile.

Finally, it is also possible to configure the trilobate profile of the male and female coupling zones to make the coupling on both the sides and the lobes.

A particularly advantageous application of the invention is the one relating to the coupling of a bicycle pedal crank to the bottom bracket spindle. Nonetheless, it will be evident that the invention is applicable to the coupling of any bicycle component.

In the case of application to the spindle-crank coupling, a further preferred aspect of the invention lies in the fact that the aforesaid trilateral profile has a vertex substantially positioned on the median axis of the pedal crank. Preferably, moreover, the trilateral profile has an axis of symmetry (meaning that the profile is in the shape of a substantially isosceles or substantially equilateral triangle) which is aligned on the median axis of the pedal crank and intersects the axis of the spindle. Still preferably, the vertex of the trilateral profile positioned on the median axis of the pedal crank points in the direction of the nearest end of the pedal crank.

Again according to a further preferred aspect, the trilateral profile is on an end portion of the bottom bracket spindle and the coupling cavity of the pedal crank has an end wall and the trilateral profile is in a portion immediately adjacent to said end wall. Preferably, moreover, the end portion of the spindle has an end surface with a peripheral bevel or chamfer that can be used to promote easy assembly of the spindle inside the pedal crank cavity. Again preferably, in the assembled condition, the aforesaid end portion of the spindle is in contact with said end wall of the pedal crank.

In the preferred embodiment, the aforesaid end wall has an opening for the passage of a lock screw destined to engage a threaded hole formed axially in the spindle from its end surface. This provides axial locking of the pedal crank on the spindle.

According to a further preferred aspect, the aforesaid opening in the end wall of the pedal crank is composed of a threaded hole with a larger diameter than the aforesaid hole for engaging the lock screw, said threaded hole with a larger diameter formed in the pedal crank being destined to engage a screw extractor tool to press the surface of the spindle out of the cavity in the pedal crank when spindle and pedal crank are to be decoupled.

In the aforesaid preferred embodiment, spindle and pedal crank are produced with the same material, in order to avoid any risk of stress corrosion (battery effect) and relative micro-movements that could produce cracks caused by the use of different materials, such as aluminum and steel. The common material chosen for spindle and pedal crank is preferably selected from steel, aluminum or its alloys, or a fabric based on structural fibres incorporated in a matrix of plastic material, said fibres being comprised of carbon, glass, aramide, boron, ceramic or any combination of these.

According to another aspect, the invention also relates both to a bicycle pedal crank on its own and to a bottom bracket spindle of a bicycle on its own, configured in such a way to produce, together with the respective part coupled to it, a coupling as defined above.

### BRIEF DESCRIPTION OF THE DRAWINGS

Further characteristics and advantages of the invention shall become clear from the following description and the accompanying drawings, which are provided as non-limiting examples, in which the same numerals represent the same elements:

FIG. 1 is an exploded perspective view of a basic coupling configuration according to the invention;

FIGS. 2, 3 are exploded perspective views of a bottom bicycle bracket spindle and pedal crank coupling according to the invention;

FIG. 4 is an enlarged scale sectional view of a coupling according to the invention;

FIG. 5 is an exploded partial, detailed sectional view of the connection in FIG. 4;

FIGS. 6, 7 are a front and rear elevations of a pedal crank according to the invention;

FIG. 8 is a sectional view according to the line VIII-VIII of FIG. 7;

FIG. 9 is an enlarged scale view of the detail IX of FIG. 6;

FIGS. 10, 11 are variants, in relevant fragments, of the configuration illustrated in FIGS. 6, 7;

FIG. 12 is a section, in relevant fragment , according to the line XII-XII of FIG. 11;

FIG. 13 shows, on an enlarged scale, the detail XIII of FIG. 10; and

FIGS. 14-29 are variants of the trilateral profile according to the invention.

### DETAILED DESCRIPTION OF THE PREFERRED EMBODIMENTS

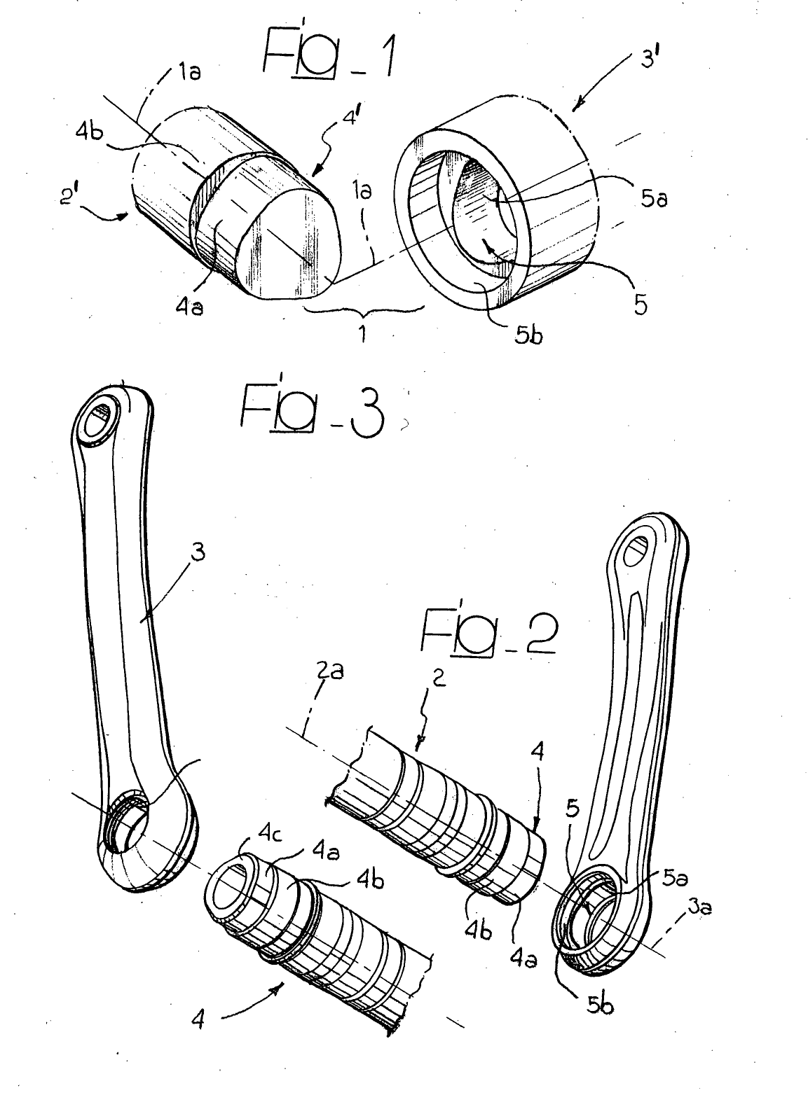

In FIG. 1, number 1 indicates as a whole a component coupling according to the invention. This illustrated invention is applicable for instance to the connection between a bicycle pedal crank and the pedal spindle associated with it, or between the seat or saddle post and the seat tube of the bicycle frame, or between the bicycle front fork column and the handlebar, or to the connection between the meshing sprockets of the bicycle chain which are associated with the hub of the rear wheel with the freewheel body on which they are assembled.

According to the configuration of FIG. 1, the coupling 1 comprises a first coupling component 2′ and a second coupling component 3′ respectively having a male coupling zone or element 4′ and a female coupling zone or cavity 5. The coupling zones 4 and 5 have reciprocal engaging surfaces including first portions of surface 4a, 5a which in a section perpendicular to a common coupling axis have a trilateral profile with rounded vertices, defined herein as trilobate profile. The lobes of the profile are formed by the rounded vertices. As shown in FIG. 1, the first portion 4a of the male element 4′ presents the trilobate profile in an end portion of the male element 4. Provided adjacent to this is a second cylindrical portion 4b. The second portion 4b is received inside a corresponding second portion 5b of the coupling cavity 5. According to the invention, the portions of surface 4a, 5a and 4b, 5b are dimensioned to couple with an interference fit. The function of the cylindrical coupling of the two second portions of surface 4b, 5b is correct positioning of the two elements 2′, 3′. Nonetheless, it is evident that the two second portions of surface 4b, 5b may even be omitted or reversed in their order of presentation, without however departing from the scope of the present invention.

FIG. 1 does not illustrate any further locking means of the two elements 2, 3 in the coupled condition. Theoretically, an assembly with an interference fit could prevent undesired axial withdrawal of the two components, relative to each other. In practice, it is preferable to include means for axially fixing the two components together. As shall be seen hereunder, the invention contemplates the common practice of utilizing a screw that engages an axial threaded hole to ix the elements relative to each other.

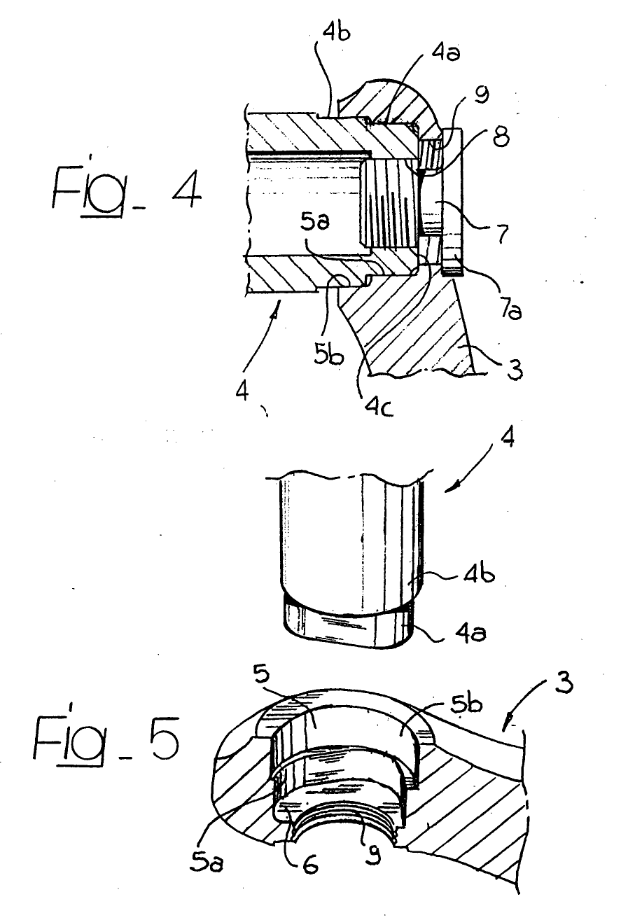

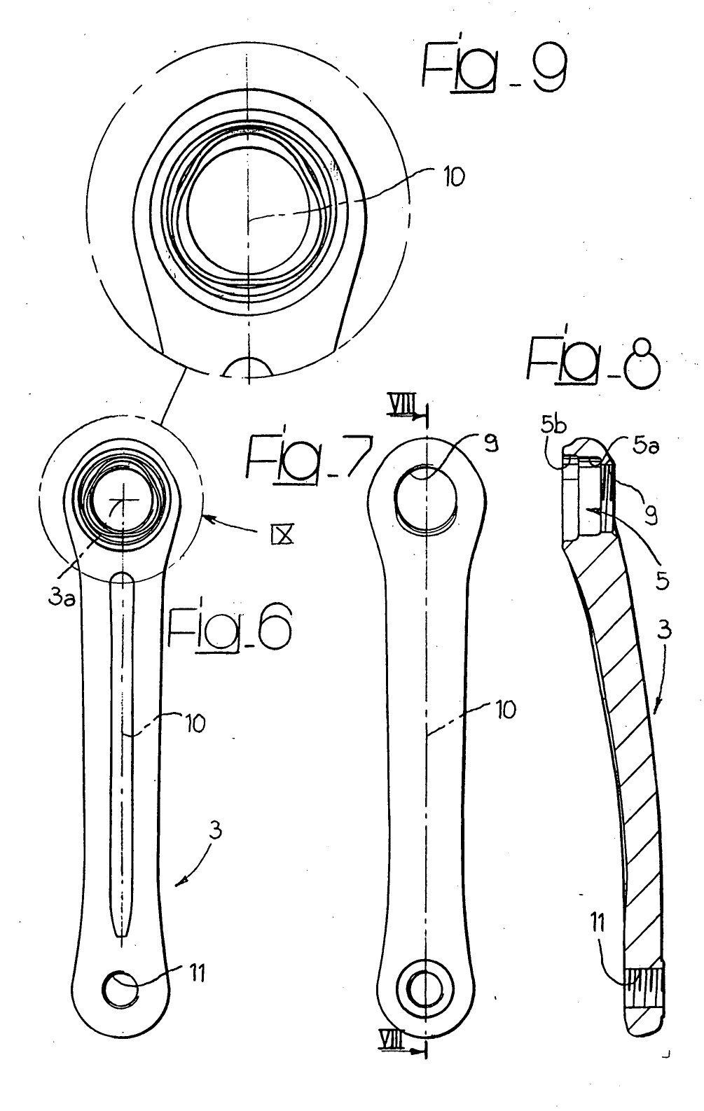

FIGS. 2-8 illustrate an example of the invention as applied to a bicycle pedal crank and bottom bracket spindle. In FIGS. 2, and 3, the reference number 2 indicates the bottom bracket spindle of the bicycle and reference number 3 indicates a bicycle pedal crank. At one end the pedal crank 3, cavity 5 defining the female element of the coupling. The end portion 4, of element 2, includes a portion 4a with trilobate profile and adjacent portion 5b of element 3 having a circular profile. As can be clearly seen in this FIG. 6, the coupling cavity 5 terminates in an end wall 6 which acts as stop for the end surface of the spindle 4 in the coupled condition, as is evident from the sectional view of FIG. 4. Axial locking of the coupling is obtained by means of a screw 7 with a threaded leg that engages a threaded axial hole 8 formed in the spindle 4 from its end surface 4c. The screw 7 has a head 7a that rests against the pedal crank 3 to hold the elements 3, 4 in the coupled condition.

In FIGS. 2 and 3, the end of the spindle 4 opposite to the one with the trilobate profile is illustrated as fragmented. It is possible for this end to have a conformation identical to the one described above.

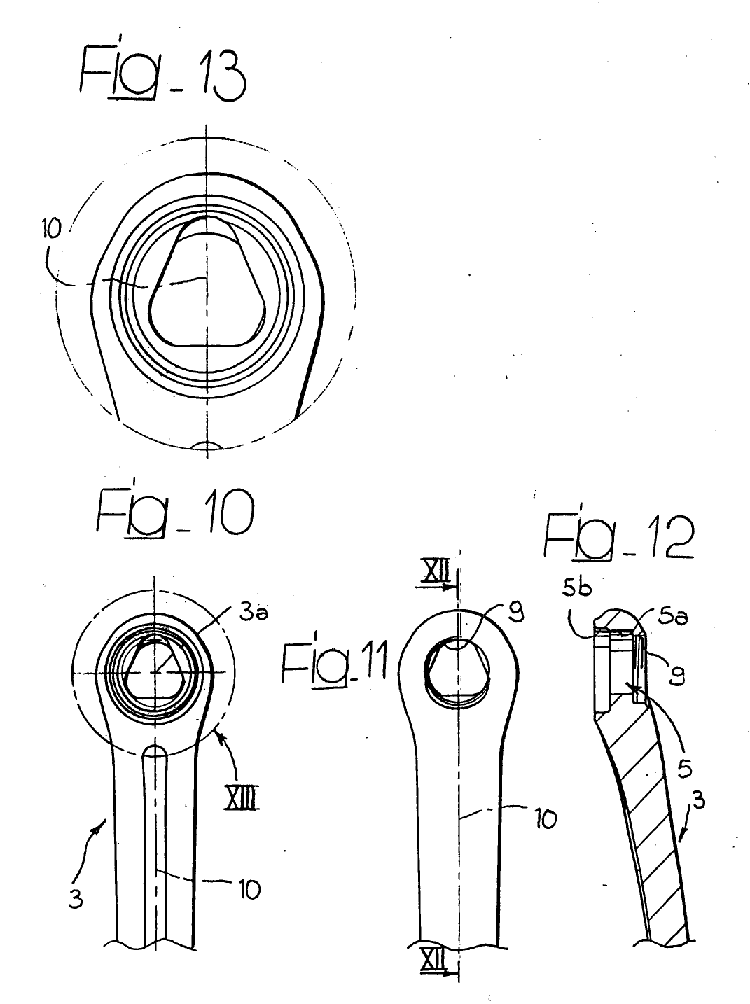

FIGS. 6-9 illustrated front elevation and sectional views of the coupling cavity 5. In these figures, the three sides of the triangular profile with rounded vertices, or trilobate profile, are substantially rectilinear and equal to one another, substantially analogous to an equilateral triangle. The variant illustrated in FIGS. 10-13 differs from the one above mainly in that the trilobate profile is substantially similar to an isosceles triangle. In any case, the triangle has a vertex aligned on the median axis 10 of the pedal crank 3 (see FIGS. 6, 9, 10 and 13) with this vertex pointing in the direction of the end nearest to the pedal crank. In both cases, moreover, the theoretic triangle that produces the trilobate profile has an axis of symmetry coinciding with the median axis 10 of the pedal crank. This characteristic is provided efficient transmission of torsional stress in relation to the axis of the spindle 4 between spindle and pedal crank.

During use, the trilobate profile coupling surfaces provide transmission of torsional stresses, while coupling of the cylindrical surfaces 4b, 5b guarantees correct relative positioning of the two elements, especially with reference to possible misalignments of the axis 2a of the spindle 2 with the axis 3a of the coupling cavity 5 of the pedal crank 3. At the other end, the pedal crank 3 has a threaded through hole 11 for connection to the spindle of the relative bicycle pedal, according to known technique.

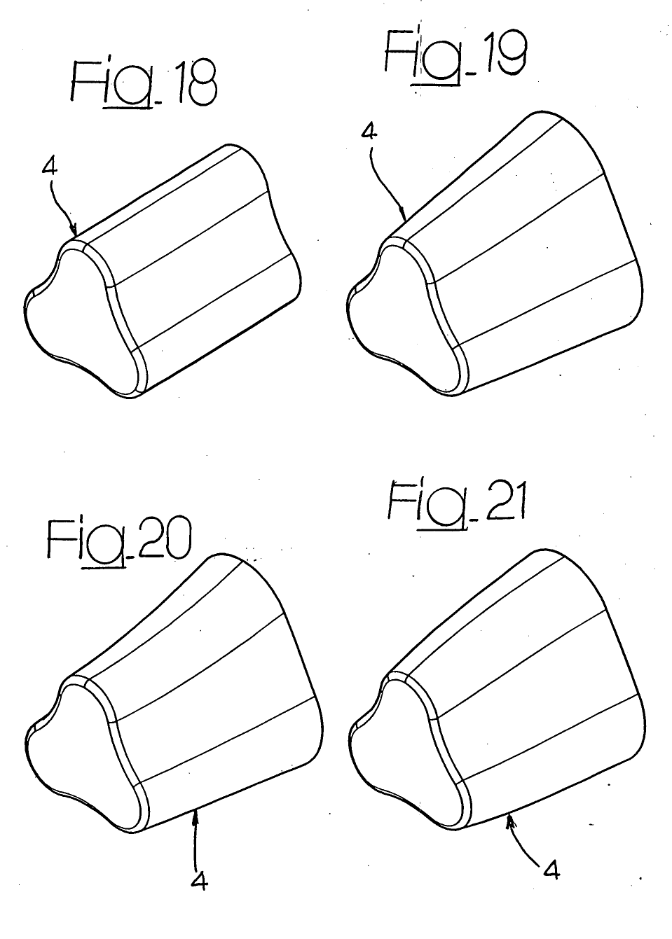

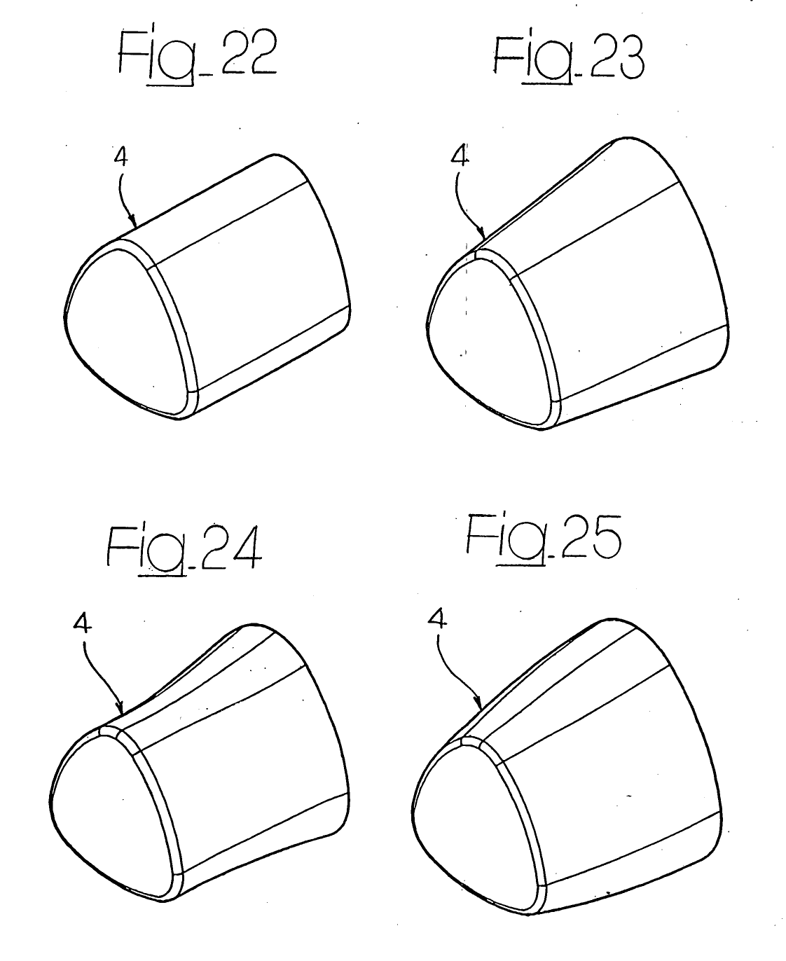

As previously indicated, different variants of the trilateral shaped coupling profile are possible according to the present invention. For example, one or more sides of the triangle may not be rectilinear, but curved at least partly, and arched towards the centre or towards the outside of the triangle. In particular, it is possible for the coupling surfaces of the male element and the coupling female cavity to be in contact only along a line of the three lobes or vertices of the profile. For example, it is possible to give a concave conformation to the sides of the trilobate profile of the spindle, or to those of the coupling cavity, or both to the former and to the latter (see FIGS. 18-21). Or yet again, it is possible to produce a trilobate profile with sides arched towards the outside (see FIGS. 22-25) so that coupling by rotation is produced only in line with these sides. Lastly, it is of course possible to produce a profile in which coupling is obtained both on the lobes and on the sides. It is also possible for the portions of surface with trilobate profile to have a tapered configuration , rather than an axially uniform section like the one illustrated.

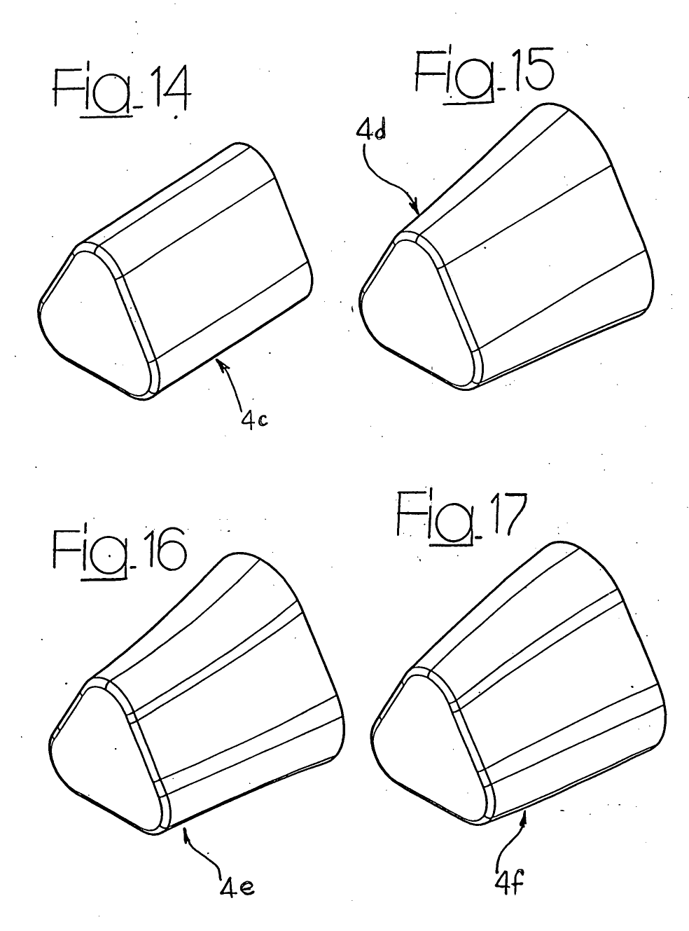

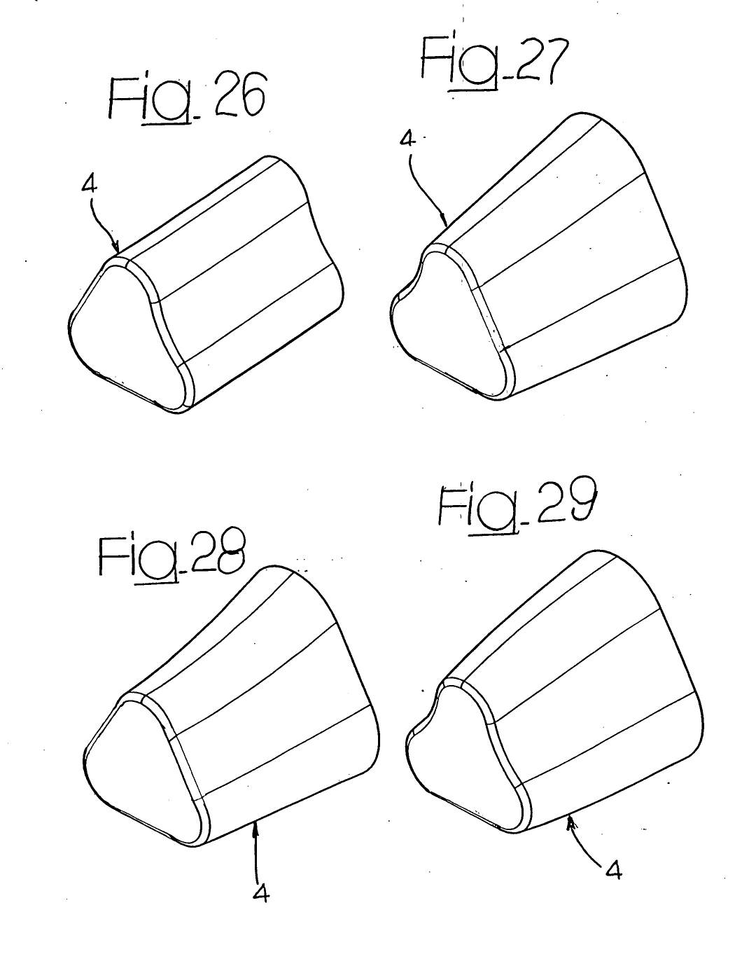

With a view to this, FIGS. 14 through 29 illustrate various possible configurations similar to the male element 4, designated 4c-4r, respectively. While FIG. 14 shows an element 4c with a cylindrical conformation (in the sense that it has parallel straight generating lines) and, therefore, it has an axially uniform section, FIGS. 15-17 show tapered conformations. In particular, FIG. 15 illustrates a conic conformation 4d with rectilinear generating lines, with total cone angle between 1° and 45°, preferably between 5° and 10°. FIG. 16 shows a saddle-shaped tapered configuration 4e, with generating profile arched towards the inside. Finally, FIG. 17 shows a slightly convex tapered configuration 4f, with generating profile arched towards the outside. According to each of the aforesaid cases, the female coupling zone has a complementary configuration.

The advantage of the tapered configuration is that it provides easy and correct coupling at assembly, without the need for costly precision machining.

FIGS. 18-21 are variants of FIGS. 14 through 17 which differ from the former solely in the conformation of the trilateral profile of the male section. In these cases, the three sides of the profile are arched towards the inside in order to generate a profile with three radial petals.

Finally, the aforesaid FIGS. 22-29 show variants with sides arched, a combination of straight and arched sides and differences in the size and arrangement of the trilateral sides. It will be recognized by those skilled in the art after having the benefit of this disclosure that the sizes and angles between and among the trilateral elements may be varied according to the application and specific needs, such as alignment between the components.

As already mentioned above, one solution of the present invention is to produce a coupling in which the coupling surfaces have a profile defining a plurality of coupling lobes spaced angularly from one another around a coupling axis. Although the lobes illustrated are three in number, the number of lobes may deferrer according to the application, however, the lobe must be detectable in order to appreciate the advantages of the present invention.

What is claimed is:

1. A coupling between two bicycle components, said coupling comprising: a male coupling element having an end portion with a trilateral profile and an intermediate portion adjacent to the end portion having a circular profile; and
a female coupling element having an end portion with a complementary circular mating profile engageable with said intermediate portion of said male coupling element, and an intermediate portion adjacent to the end portion having a complementary trilateral mating profile engageable with said end portion of said male coupling element, the male and female coupling elements being moveable from an uncoupled configuration to a coupled configuration.

2. The coupling of claim 1, wherein said male coupling element is a bottom bracket spindle and the female coupling element is a pedal crank.

3. The coupling of claim 1, wherein said intermediate portion of said male coupling element and said end portion of said female coupling element are each dimensioned to engage each other with interference.

4. The coupling of claim 1, wherein said intermediate portion of said male coupling element and said end portion of said female coupling element are each dimensioned to slidingly engage each other.

5. The coupling of claim 1, wherein each of said substantially trilateral profiles of said end portion of said male coupling element and said intermediate portion of said female coupling element is of a trilobate-type.

6. The coupling of claim 5, wherein each of said trilobate profile of said end portion of said male coupling element and said trilobate profile of said intermediate portion of said female coupling element zone is configured to produce said coupled configuration of said coupling aligned with three lobes.

7. The coupling of claim 6, wherein said trilobate profile of said end portion of said male coupling element comprises concave or rectilinear sides, and said trilobate profile of said intermediate portion of said female coupling element comprises respective convex or rectilinear sides.

8. The coupling of claim 5, wherein said trilobate profile of said end portion of said male coupling element and said trilobate profile of said intermediate portion of said female coupling element are configured in to produce said coupled configuration of said coupling aligned with three sides.

9. The coupling of claim 8, wherein said trilobate profile of said end portion of said male coupling element comprises convex or rectilinear sides, and said trilobate profile of said intermediate portion of said female coupling element comprises respective concave or rectilinear sides.

10. The coupling of claim 5, wherein the trilobate profile of said end portion of said male coupling element and said trilobate profile of said intermediate portion of said female coupling element are configured to produce said coupled configuration of said coupling aligned with three lobes and with three sides.

11. The coupling of claim 5, wherein the trilobate profile of said end portion of said male coupling element further comprises a peripheral bevel.

12. The coupling of claim 1, wherein said male and female coupling elements are comprised of the same material.

13. The coupling of claim 12, wherein said material is selected from aluminum, aluminum alloys, steel, and fabric based on structural fibers incorporated in a matrix of plastic material.

14. The coupling of claim 1, wherein said male element further comprises a lateral surface transitioning between said intermediate portion and said end portion, and said female element further comprises a lateral surface transitioning between said intermediate portion and said end portion,
whereby said lateral surfaces come in contact with each other during said coupled configuration of said coupling.

15. The coupling of claim 2, wherein the bottom bracket spindle comprises first and second ends and threaded axial apertures that engage fixing screws, said apertures being threaded in the same direction.

16. The coupling of claim 2, wherein the bottom bracket spindle comprises first and second ends and threaded axial apertures that engage fixing screws, said apertures being threaded in the opposite direction.

17. The coupling of claim 2, wherein the pedal crank comprises an opening sufficient to allow the passage of a fixing screw, said fixing screw engagable in a threaded aperture of the bottom bracket spindle.

18. The coupling of claim 17, wherein the opening is larger than the threaded aperture of the bottom bracket, said opening having threads engageable with a screw extraction tool that presses the end of the spindle out of the intermediate female portion then the spindle and crank are required to be decoupled.

19. The coupling of claim 1, wherein said male coupling element is a pedal spindle and the female coupling element is a pedal crank

20. A bicycle drive assembly, comprising:
a) a bicycle bottom bracket spindle;
b) at least one bicycle pedal crank; and
c) a coupling defined by at least one trilateral male member with a circular portion adjacent thereto on the bicycle bottom bracket spindle and a complementary trilateral adjacent to a circular mating recess defined in the bicycle pedal crank that establishes an interference fit coupling between the assembled bottom bracket spindle and at least one pedal crank.

21. A coupling between two bicycle components, said coupling comprising:
a male coupling element having an end portion with a trilateral profile and an intermediate portion adjacent to the end portion having a circular profile defining a first abutment; and
a female coupling element having an end portion with a complementary circular mating profile engageable with said intermediate portion of said male coupling element, and an intermediate portion adjacent to the end portion having a complementary trilateral mating profile engageable with said end portion of said male coupling element defining a second abutment, said second abutment acting as a stop for the end surface of the male coupling element when the male and female coupling elements are in a coupled configuration.
